(19) United States
(12) Patent Application Publication
(10) Pub. No.: US 2007/0081606 A1
(43) Pub. Date: Apr. 12, 2007

(54) Multiple-input multiple-output communication system

(76) Inventor: Josi Rosenfeld, London (GB)

Correspondence Address: PHILIPS INTELLECTUAL PROPERTY & STANDARDS, P.O. BOX 3001, BRIARCLIFF MANOR, NY, 10510, US

(21) Appl. No.: 10/548,339

(22) PCT Filed: Feb. 27, 2004
(86) PCT No.: PCT/IB04/00658

§ 371 Date: Nov. 30, 2006

(30) Foreign Application Priority Data
Mar. 11, 2003 (GB) 0305486.3

(51) Int. Cl. H04L 1/02

(52) U.S. Cl. 375/267

(57) ABSTRACT

Radio stations (10, 20) include a variety of propagation models. A radio signal is transmitted from a first to a second radio station, and the received signal is fitted to a plurality of models. Alternatively, the correlation of the received signals is fitted to models. The received signals are processed based on the best fit model, and the corresponding propagation effects. In some cases, the model can be used to correct for propagation effects. In other cases, other techniques such as beam steering can be used.

The invention relates to wireless multi-input multi-output (MIMO) communications and positioning and particularly to a receiving method, a radio station and a computer program that address local propagation effects.

A multi-input multi-output (MIMO) system has a plurality of transmit antennas and a plurality of receive antennas. The use of the multiple antennas allows multiple transmission channels to be used which can improve performance, and transmission capability.

The functioning of MIMO communications and positioning systems is highly dependent on the propagation effects in the environment.

Signals travelling between a transmitter and a receiver need not take the direct, line of sight (LOS) path, but can take any of a number of paths and arrive at slightly different times. The received signal is therefore the sum of a direct, LOS signal and the signals received on the multiple paths. The statistical properties of these signals are complex.

US 2002/0027957 A1 to Paulraj et al describes a technique of transmitting from first and second transmitters and introducing a delay in the transmission of the signal from one transmitter so that the signals are received coherently at a specific point in the coverage area. Although this may reduce interference effects at one location, it is of little use in systems where the locations of the receivers are not known.

Another document, US 2002/0177447 A1 to Walton et al, describes a MIMO system and refers to various space time processing methods, including minimum mean square estimator (MMSE) and others. This technique is used in conventional single channel systems for multipath mitigation. MMSE has the advantage over alternative techniques that it is reasonably robust in the presence of noise. The disadvantage of this technique is that it is computationally intensive since it requires many iterations to estimate parameters.

However, there remains a need for an improved method of MIMO communications and/or positioning.

According to the invention there is provided a multiple input multiple output wireless signal receiving method, including:

providing a plurality of predetermined propagation models corresponding to different transmission environments;

receiving a received signal or signals transmitted from a first radio station;

fitting to the plurality of predetermined propagation models at least one of the received signal or signals or a correlation function of the received signal or signals, and identifying the propagation model that gives the best fit; and

processing the signal or signals based on the identified propagation model.

In preferred arrangements, the method includes providing signal reception improvement methods corresponding to the predetermined propagation models and receiving signals from the first radio station whilst operating a signal reception improvement method or methods corresponding to the best fit propagation model.

The inventor has realised that no one signal optimisation method is suitable in MIMO devices in all environments. Therefore, in the invention the processing method is adjusted “on the fly” to adapt to differing circumstances.

This allows for minimum power to be used to transmit signals, and in particular it is expected that the method will use considerably less power than ultrawideband (UWB) methods alone.

The term “radio” is not intended to limit to any particular frequency band of the electromagnetic spectrum.

In embodiments, the step of receiving a signal includes receiving a first signal from the first radio station; the step of fitting at least one received signal includes fitting the first signal; and the method further includes receiving a further signal or signals from the first radio station and processing the further signal or signals based on the identified model.

In a preferred embodiment the method of fitting the signal includes providing a plurality of different functions of received power against time, corresponding to different propagation models, each having at least one parameter; and fitting the received signal to each of the plurality of functions to obtain the function that gives the best fit to the received signal and the corresponding at least one best fit parameter.

The identified model may alternatively or additionally be used for reducing power consumption, increasing the data rate and/or increasing equalization processor speed based on the identified model.

The models may include a diffuse scattering model in which the received signal as a function of time is given by:

$$r ( t ) = B {ⅇ}^{- α t} [ \frac{{τ}_{0} \sqrt{{t}^{2} - {τ}_{0}^{2}}}{{t}^{2}} + 1 ] \qquad ( 1 )$$

where r(t) is the received signal as a function of time t, a, B and τ₀ are fitting parameters.

Likewise, the models may include a specular reflection model in which the received signal as a function of time is given by:
r(t)=α₀e^{iθ}^{₀}s(t−τ₀)+α₁e^{iθ}^{₁}s(t−τ₁) (2)
where α₀, α₁, τ₀ and τ₁ are fitting parameters, and θ₀ and θ₁ are the phases of the signals which are likewise fitting parameters.

Where it is determined that the best fit model is the diffuse scattering model, beam steering is not an appropriate way of signal processing, that is to say, beam steering does not reduce power and/or increase the date rate. In this case, the model in equation (1) can be used to aid the speed of processing by a rake receiver or for positioning to mitigate the multipath to obtain the range with accuracy and little processing.

In contrast, where it is determined that the best fit model is a one specular reflection model, beam steering may be applied.

An alternative approach to fitting to models includes transmitting a first signal of known form. The step of fitting the received signal may then include calculating the correlation of the received signal with the known form as a function of delay and fitting the correlation as a function of delay to the plurality of different models.

The signals transmitted may be pure data signals for a data transmission application, such as mobile telephony or providing data transfer between computers connected to the first and second radio stations.

Alternatively, the signals transmitted may be ranging signals.

In another aspect, the invention relates to a computer program product for causing a radio station to operate the methods set out above. The computer program product may in particular be recorded on a data carrier.

The invention also relates to a radio station comprising:

a plurality of antennas;

a transceiver for transmitting signals and receiving signals through the antennas;

a processor for controlling the radio station;

at least one memory for storing code and data, including a plurality of predetermined propagation models corresponding to different transmission environments and corresponding signal transmission improvement methods;

wherein the radio station is arranged to:

receive a signal from another radio station;

to fit the received signal to the plurality of predetermined propagation models and to identifying the propagation model that gives the best fit to the received signal; and

to process the received signal or further signals based on the best fit propagation model and the corresponding signal reception improvement method.

For a better understanding of the invention, embodiments will now be described, purely by way of example, with reference to the accompanying drawings, in which;

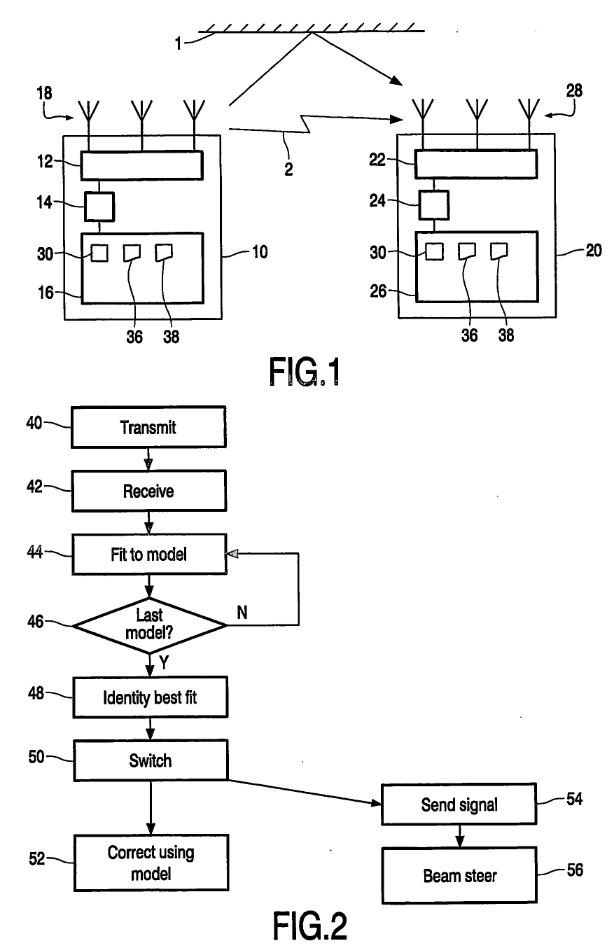

FIG. 1 shows a system according to the invention; and

FIG. 2 shows a flow chart of the operation of a system according to the invention.

Referring to FIG. 1, a first radio station 10 has a transceiver 12, a processor 14 to control the radio station, and a memory 16. A plurality of antennas 18 for radio frequency transmission are also provided. A second radio station 20 likewise has a transceiver 22, a processor 24 and a memory 26, together with a plurality of antennas 28.

The antennas 18,28, processors 14,24, memory 16,26 and transceivers 12,22 can be implemented as is well known to those skilled in the art and so their details will not be described further.

The memory 16,26 of each radio station 10, 20 includes code 30 for controlling the operation of the radio station to carry out the operational steps described below, together with data 36, 38 about different propagation mechanisms.

In use, a time-limited radio signal 2 is transmitted (step 40) from the first radio station 10 to the second radio station 20. The signal travels both directly and after reflection off walls 1. The signal is received (step 42) and tested by fitting to a number of propagation models.

In a first propagation model, the received signal is fitted to a diffuse scattering model (step 44). In this model, calculation shows the diffuse scattered signal received to have the form

$$r ( t ) = B {ⅇ}^{- α t} [ \frac{{τ}_{0} \sqrt{{t}^{2} - {τ}_{0}^{2}}}{{t}^{2}} + 1 ] \qquad ( 1 )$$

where r(t) is the received signal as a function of time t, α, B and To are fitting parameters where τ₀ is the delay of the line of sight.

In a second propagation model, the received signal is fitted (step 44) to a specular reflection model in which the received signal is assumed to be reflected off one specular reflector. The received signal is fitted to a curve of the form
r(t)=α₀e^{iθ}^{₀}s(t−τ₀)+α₁e^{iθ}^{₁}s(t−τ₁) (2)

where α₀, α₁, τ₀ and τ₁ are fitting parameters. θ₀ represents the phase of the signal received along the direct path and θ₁ the phase of the signal received along the reflected path. The parameters with subscript 0 correspond to a direct line of sight signal and the parameters with subscript 1 to the signal that is reflected off a single reflector.

Other models may be included if required. For example, equation (2) can be modified by adding an additional term or terms to represent a model with n specular reflectors, where n is an integer at least 2:

$$r ( t ) = {\sum }_{j = 0}^{n} {α}_{j} {ⅇ}^{t {θ}_{n}} s ( t - {τ}_{j} ) \qquad ( 3 )$$

or with both specular and diffuse scattering

$$r ( t ) = {\sum }_{j = 0}^{n} {α}_{j} {ⅇ}^{t {θ}_{n}} s ( t - {τ}_{j} ) + B {ⅇ}^{- α t} [ \frac{{τ}_{0} \sqrt{{t}^{2} - {τ}_{0}^{2}}}{{t}^{2}} + 1 ] \qquad ( 4 )$$

The received signal is fitted to these propagation models in turn (step 46) and any other propagation models that may be included. The model that gives the best fit is determined (step 48).

Parameter estimation techniques to carry out the best fit approach are known. One example is the Multi-path Estimating Delay-Lock Loop (MEDLL) (see, for example, “Performance Evaluation of the Multi-path Estimating Delay Lock Loop”, B. Townsend, D. J. R. van Nee, P. Fenton, and K. Van Dierendonck, Proc of the Institute of Navigation National Technical Meeting, Anaheim, Calif., Jan. 18-20, 1995, pp. 227-283). Another is the Minimum-Mean-Square-Estimator (MMSE) (see, for example, “Conquering Multi-path: The GPS Accuracy Battle”, L. R. Weill, GPS World, April 1997). In parameter estimation techniques, the received signal is represented by a mathematical model, for example a model that includes variable parameters and the parameter values are adjusted iteratively until a good match is obtained between the received signal and the mathematical model.

Depending on the propagation model identified as giving the best fit, a different approach to signal optimisation is adopted. Accordingly, processing is caused to follow a different path depending on the best fit model (step 50), thereby operating a preferred signal reception improvement mechanism.

In particular, if the diffuse scattering model is determined to give the best fit the signal is optimised by using formula (1) with the best fit parameters to estimate and correct for the multi-path effects caused by the diffuse scatterers. The skilled person will be aware of how this can be achieved and accordingly no further details will be provided here. Data signals are transmitted by the first radio station 10, received by the second station 20 and corrected (step 52) using formula (1) and the best fit parameters.

Alternatively, if the single specular reflection model gives a better fit to the observed data, then a beam steering method (step 56) is used to increase data rate.

In a development of the first embodiment, the direction from which the signal is received is determined, and used to assist in increasing data rate, by aiding beam steering, for example.

The invention uses a number of different techniques for optimising signal transmission and reception as required by the local environment of the radio stations. In this way, the MIMO system can maintain a high data rate and/or a low power and/or faster processing.

The invention is particularly beneficial in that different models can be used in both local indoor environments and outdoors which may often have very different radio signal transmission properties. MIMO is very susceptible to different environments and these can change drastically over time. This is very difficult for conventional systems to cope with. Even within a room a mobile MIMO system will encounter a variety of propagation effects.

In an alternative embodiment, the signals sent between the radio stations 10, 20 are not data signals per se but ranging signals used to determine the distance between the radio stations 10, 20. This may be done by measuring the time of flight of the radio signal sent between stations 10, 20, and this in turn needs correction for multi-path effects, using the identified parameter estimation models.

The propagation models used do not need to be functions of received signal against time. Instead, the transmitted signal can be of known form and the received signal can be correlated with the known form of the transmitted signal as a function of delay. In the absence of multi-path effects, if the only signal was the direct line of sight signal, the correlation function would be expected to be zero except for a triangular peak centred around the delay that represented the time delay between the transmitted and received signals. This shape is smeared substantially by multi-path effects.

Accordingly, the correlation shape as a function of delay can be measured and this can be fitted to various signal propagation models to find the best fit, and thus identify the propagation conditions so that an on-the-fly optimisation decision can be made. This correlation approach is particularly suitable for ranging systems which in any event calculate the correlation, but the correlation method could also be used to find the dominant propagation model for use in data transmission.

In alternative arrangements according to the invention, alternative or additional processing decisions could automatically be made given the dominant propagation mechanism. For example, the system could automatically shut down when an identified propagation effect is bad. As another example, if the diffuse case is identified, processing can be reduced and/or data rate increased by mitigating the diffuse multipath from the received signal using the diffuse propagation model rather than using the equalisation process.

The invention may be used in a number of applications, including ranging, locating people, objects, warning devices, games and sports.

The information collected about the local propagation model can be mapped to build up a map of the local environment.

The way in which the received signal is fitted may be varied. For example, the model may include or disregard the phase of signal components of the received signal and model only the envelope, or the envelope and phone.

Optionally the reflectivity μₖ of the reflectors may be a parameter in the model, in which case the parameter estimation can yield values for the reflectivity μₖ. These can be exploited to determine the material of the walls 1 in conjunction with a data base of reflectivity values for various materials. Such knowledge of the material can provide supplementary information to aid identification of the location of the target 20, or optionally the angle of arrival θₖ could be included in the parameter estimation to aid beam steering.

Although the invention has been described with respect to a radio signal, other wireless signals such as light, infra-red, or ultrasound, may also be used.

In the present specification and claims the word “a” or “an” preceding an element does not exclude the presence of a plurality of such elements. Further, the word “comprising” does not exclude the presence of other elements or steps than those listed.

From reading the present disclosure, other variations and modifications will be apparent to persons skilled in the art. Such variations and modifications may involve equivalent and other features which are already known in the design, manufacture and use of radio systems and which may be used in addition to or instead of features described herein. Although the appended claims relate to particular combinations of features, it should be understood that the scope of disclosure also includes any novel feature or any novel combination of features disclosed herein either explicitly or implicitly or any generalisation thereof, whether or not it mitigates any or all of the same technical problems as does the present invention. The applicants hereby give notice that new claims may be formulated to any such features and/or combinations of such features during the prosecution of the present application or of any further applications derived therefrom.

1. A multiple input multiple output wireless signal receiving method, including:
providing a plurality of predetermined propagation models corresponding to different transmission environments;
receiving (42) a received signal or signals transmitted from a first radio station (10);
fitting (44, 46, 48) to the plurality of predetermined propagation models at least one of the received signal or signals or a correlation function of the received signal or signals, and identifying the propagation model that gives the best fit; and
processing (52, 54, 56) the signal or signals based on the identified propagation model.

2. A multiple input multiple output wireless signal receiving method according to claim 1,
wherein the step of receiving a signal includes receiving a first signal from the first radio station;
the step of fitting at least one received signal includes fitting the first signal;
the method further comprising receiving a further signal or signals from the first radio station and processing the further signal or signals based on the identified model.

3. A method according to claim 1 further comprising providing signal reception improvement methods (52) corresponding to the predetermined propagation models and wherein the step of processing the signal or signals includes operating a signal reception improvement method or methods corresponding to the best fit propagation model.

4. A method according to claim 1 wherein the step of fitting the signal includes:
providing a plurality of different functions of received signal against time, each having at least one parameter, and each corresponding to a different propagation model; and
fitting the received signal to each of the plurality of functions to obtain the function that gives the best fit to the received signal and the corresponding at least one best fit parameter.

5. A method according to claim 4 wherein the models include:
a diffuse scattering model represented by
$$r ( t ) = B {ⅇ}^{- α t} [ \frac{{τ}_{0} \sqrt{{t}^{2} - {τ}_{0}^{2}}}{{t}^{2}} + 1 ]$$
where r(t) is the received signal as a function of time t from transmission, α, B and τ₀ are fitting parameters and
a specular reflection model of the form
r(t)=α₀e^{iθ}^{₀}s(t−τ₀)+α₁e^{iθ}^{₁}s(t−τ₁)
where α₀, α₁, τ₀ and τ₁ are fitting parameters.

6. A method according to claim 5 wherein if the diffuse scattering model gives the best fit the corresponding signal transmission improvement method includes correcting for multi-path effects by correcting for the diffuse scattering assumed to be of the form:
$$r ( t ) = B {ⅇ}^{- α t} [ \frac{{τ}_{0} \sqrt{{t}^{2} - {τ}_{0}^{2}}}{{t}^{2}} + 1 ]$$
with the parameters α, B and To determined in the fitting step.

7. A method according to claim 5 wherein if the specular method model gives the best fit the signal transmission improvement method includes beam steering.

8. A method according to claim 1 wherein the first signal is of known form and the step of fitting the received first signal includes calculating the correlation of the received signal with the known form as a function of delay and fitting the correlation as a function of delay to the plurality of different models.

9. A method according to claim 1 wherein the signal or signals are ranging signals.

10. A method according to claim 1 further including reducing power consumption, increasing the data rate and/or increasing equalization processor speed based on the identified model.

11. A computer program product for causing a radio station to operate to carry out the method according to claim 1.

12. A radio station (20) comprising:
a plurality of antennas (18);
a transceiver (22) for transmitting signals and receiving signals through the antennas;
a processor (24) for controlling the radio station;
at least one memory (26) for storing code and data, including a plurality of predetermined propagation models corresponding to different transmission environments and corresponding signal reception improvement methods;
wherein the radio station is arranged to
receive a signal (2) from another radio station (10);
to fit the received signal to the plurality of predetermined propagation models and to identifying the propagation model that gives the best fit to the received signal (2); and
to process the received signal or further signals based on the best fit propagation model and the corresponding signal reception improvement method.
